(19) United States
(12) Patent Application Publication
(10) Pub. No.: US 2005/0109285 A1
(43) Pub. Date: May 26, 2005

(54) Tilt-up safety hood

(75) Inventors: Roy S. Hickok, Moorpark, CA (US); Joseph Chong, Northridge, CA (US)

Correspondence Address: Pillsbury Winthrop LLP;Intellectual Property Group, 1600 Tysons Boulevard, McLean, VA, 22102, US

(73) Assignee: AQUARIA, INC.

(21) Appl. No.: 09/920,258

(22) Filed: Aug. 1, 2001

(51) Int. Cl. A01K 63/06

(52) U.S. Cl. 119/266

(57) ABSTRACT

An aquarium hood having a number of safety features is disclosed. Among these are: a collar fitting that prevents water and humidity ingress into the socket and, optionally, clips that attach the hood to the side of the aquarium so that it may be rotatably opened.

### BACKGROUND OF THE INVENTION

1. Field of the Invention

This invention relates generally to aquarium hoods, and more particularly to aquarium hoods that are designed with additional safety features that are especially helpful for those who are unfamiliar with aquariums.

2. Discussion of the Related Art

In the United States, the aquarium industry is a billion-dollar industry. Thousands of people have aquariums—both salt and freshwater. These aquariums serve many functions. To some, they are a work of art. The colorful fish and plant life in the aquarium provides an ever-changing mosaic that is wonderful to watch. Others, particularly the young users, keep fish as pets. They enjoy the daily task of feeding the fish, and seeing to their various needs. To parents, such pets are relatively easy—fish are not noisy, they will not claw furniture, and they will not use the carpet as a toilet. To children, such pets are entertaining—the children can watch these bright and colorful pets eat and swim.

In order to start and maintain their aquariums, users purchase tanks, hoods, filters, heaters, and other related products yearly. These products generally serve the purpose of creating whatever environmental factors are necessary for the fish and plant life in the aquarium. However, these products are also designed in part to please the user. For example, pumps may be designed to function more quietly so that an aquarium in a bedroom will not disrupt a light sleeper. For beginners, products are frequently designed so that they are not too complicated. This could mean an easier set-up requiring fewer hoses, or fewer parts. Some products may be packaged for beginners as “starter kits” containing many of the basics required for starting an aquarium such a tank, a hood, a heater, a filter, and a pump. These starter kits serve to facilitate new users' forays into the aquatic world. They may include directions for complete tank assembly. The store clerk who sees such a kit being purchased may be inclined to provide additional advice or information about keeping a fish tank.

However, there are at least two drawbacks that these kits, like other products known in the art, do not address. First, the products known in the art do not provide for a user-friendly hood that facilitates access to an aquarium. The hoods that are known in the art are generally To loose. That is, the user must remove the hood in order to access the tank. For all users, particularly new users, such a configuration is difficult to handle. With a loose hood, the user must find a location to place the hood while s/he is accessing the tank. Frequently, this leads to the hood being balanced over a portion of the tank while the user is reaching into the tank. This precarious position frequently results in the hood falling—either into the tank, or onto the floor or surrounding furnishings. Alternatively, the user may remove the hood. However the hood, which is typically wet, has a tendency to leave water wherever it is placed. This is not desirable for many users.

A cradle-like attachment is known in the art that may support the hood in an open position. However, such a configuration is relatively unstable. Its cradle-like configuration does not prevent the user from knocking the hood off the tank while he is accessing the tank. A hood that the user will not be able to drop is desired.

Secondly, the products known in the art do not adequately protect the light fixtures associated with aquariums from the water and condensation associated with an aquarium. It is known in the art to protect light fixtures with clear plates of hard plastic or glass. However, such sheets are relatively easy to crack. They may crack during shipping, or when being handled by the user. Since many aquarium hoods are plastic, users may treat the hood with less care than is required to protect glass. If such a small crack does occur, or if the glass is not sealed, the underside of the glass may become dirty. It is difficult to clean the side of such panels that faces the light. Such problems may lead to a dimmer light source. Alternatively, the user may simply remove the panel.

Having a light source in an area where condensation or drips/splashes from the tank may contact the light socket is extremely dangerous. At a minimum, it could lead to corrosion of the socket, and maybe a mild shock to the user. At the extreme, this could even lead to electrocution of the user. A means to protect the user from this risk that the user will not be able to easily remove is desired.

### BRIEF DESCRIPTION OF THE DRAWINGS

FIG. 1 is a perspective view of one embodiment of the present invention from a front angle when placed on a tank,

FIG. 2 is a perspective view of one embodiment of the present invention from a front angle when placed on a tank;

FIG. 3 is a perspective view of one embodiment of the present invention from a rear angle when placed on a tank;

FIG. 4 is a perspective view of one embodiment of clips that may be used in the present invention to rotationally connect the hood to a tank;

FIG. 5 is a perspective view of one embodiment of clips that may be used in the present invention to rotationally connect the hood to a tank, in which a portion of the clip may be seen fitting over the top frame of a tank;

FIGS. 6(a) and 6(b) are perspective views of one embodiment of clips that may be used in the present invention to rotationally connect the hood to a tank, in which the depicted clip is designed to fit tanks having a variety of sizes;

FIG. 7 is a perspective view of one embodiment of the present invention showing how the hood may be rotationally opened; and

FIG. 8 is a perspective view of one embodiment of the present invention showing how the collar may be fitted with the socket and the bulb.

### DETAILED DESCRIPTION

The present invention is a novel, safe aquarium hood or cover that overcomes many of the known dangerous shortcomings of the hoods that are known in the art. As such, the present invention is particularly suited for use by the young and those who are unfamiliar with aquariums. Known shortcomings with the hoods that are known in the art include a tendency for the hoods to fall, particularly into the tank, when the user is accessing the tank and a propensity for the light socket to rust or corrode due to exposure to water.

Hoods that are known in the art tend to fit loosely onto an aquarium. That is, they “sit” on the aquarium as opposed to being anchored. When the user needs to access the tank, these hoods are typically placed at an angle over the tank so that the user may reach into the tank around the hood. A hood so placed may easily be accidentally nudged or moved so that it becomes unbalanced and falls into the tank. Alternatively, the hoods may be removed by the user prior to accessing the tank. A user who attempts to replace a hood on an aquarium typically does so with hands that have been in the fish tank, and are therefore wet. Plastic hoods are typically slippery when handled with wet hands. This leads to a tendency for the hood to slip out of the user's hands as s/he is placing it on the tank. Such slippage can cause the hood to either fall into the tank, or onto a nearby surface. The removal of the hood also leads to the problem that condensation on the hood will typically dampen that which it is placed on, thereby creating unnecessary mess for the user to clean up.

Two main problems are associated with the dropping of the hood. First, if it is dropped into the tank, the fish may be startled or hit. The hood may also displace the arrangement of the accessories or rocks within the tank. Secondly, there is the risk that water will enter the socket that is associated with the light bulb. This could shock or even electrocute the user. If the hood is dropped onto a hard surface, portions of the hood may crack or break. This is particularly true if the hood includes any glass or hard plastic portions. Such breakage may make the hood unusable. Alternatively, the user may be cut by the broken materials. Both of these problems are clearly undesirable.

In order to avoid the problems associated with a hood that is not attached to the aquarium, one embodiment of the present invention may be hingeably attached to an aquarium tank. In this manner, the hood may be rotated to an open position, while remaining attached to the aquarium tank. This allows the user to access the tank, without risk that the user will accidentally drop the hood. Further, the user does not have to look for a place to set the hood while accessing the tank. An additional benefit of the present invention is the fact that any condensation that has accumulated on the hood which drips off the hood when opened will fall into the tank. These factors lead to a cleaner tank area, and a safer tank.

The hinge that is described in the present invention is particularly safe and user-friendly. The pin around which the hinge pivots is relatively easy to insert into the slots formed by the hinge portions. Additionally, since it is larger at its second end, its natural tendency is to stay in the hinge. In one embodiment of the present invention, larger second end of the pin fits through the hinge due to a slot that is cut lengthwise in the pin. This slot allows for the compression of the pin as it is pushed through the hinge portions, and expansion once the end of the pin has passed through the hinge portions. Additionally, since the hinge is assembled prior to the attachment of the hood to the tank, the user does not have to fight the forces of gravity while trying to assemble the hood and tank combination. Instead, the user may assemble the hinge on any surface s/he desires and then clip it to the tank. This ready assembly facilitates and encourages use of the safety features of the present invention.

A second problem associated with aquariums is that water has a tendency to enter into, and corrode, aquarium lights and light sockets. In order to protect the light bulbs and sockets that are associated with the hoods that are known in the art from water, it is known to place a plastic or glass sheet between the tank water and the light bulb. This serves to protect the light bulb against splashing water. However, this does not satisfactorily keep humidity away from the light socket and bulb. Additionally, such plastic or glass sheets as subject to breakage: either from dropping as described above or from the jostling that occurs during shipping. As a result, users may remove this sheet from the hood, thus defeating its purpose.

The present invention provides a sturdy, effective way to prevent water or humidity from accessing the lamp socket and bulb end. This barrier takes the form of a collar that may be attached to the lamp socket. In one embodiment of the present invention, the collar sits around the lamp socket. It may be held in place, at least in part, by a socket cover. In this manner, the light bulb may be replaced without losing the benefit of the collar.

This collar should be made of a resilient, water-resistant material. A certain amount of heat-resistance is also required to ensure that the heat from the light does not melt or otherwise damage the collar. In the preferred embodiment of the present invention, the collar is made from a heat-resistant elastomer. A benefit of the collar of the present invention is that it is attached to the hood assembly. A user may replace a spent bulb with a fresh bulb without losing the protective benefits of the collar. The fit of the collar prevents drips of condensation or splashing water from the tank from reaching the lamp socket. It also greatly reduces the amount of water that is in the air in the form of humidity from reaching the lamp socket. Since water cannot reach the lamp socket, the risk of shock or electrocution will be greatly reduced. The risk of corrosion will also be greatly reduced.

While the embodiments of the present invention shown and discussed herein generally show a hood that may house two light bulbs, it should be understood by one of ordinary skill in the art that the hood may be designed to hold any number of bulbs, for example one or three bulbs. Further, it should be understood by one skilled in the art that the present invention may be used with fluorescent, metal halide or mercury vapor lighting fixtures.

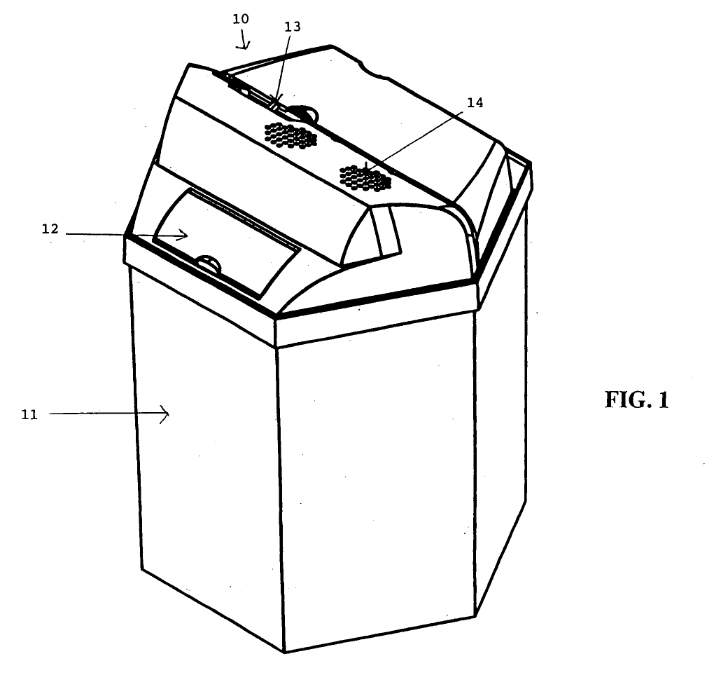

FIG. 1 is a perspective view of one embodiment of the present invention from a front angle when placed on a tank. As may be seen from FIG. 1 the hood 10, which has a generally flat portion and a generally arcuate portion, is designed to cover the top of an aquarium tank 11. The hood 10 is a top covering element that serves to prevent objects from falling into the tank. The hood 10 also serves as a housing for various accessories including, but not limited to, a lamp retaining mechanism (not shown). This mechanism includes, but is not limited to, those portions of the hood that serve to hold the lamp to the hood, those portions of the lamp that serve to hold the lamp to the hood, the lamp, and the lamp socket.

As shown in FIG. 1, the hood 10 may be equipped with an opening (see in FIG. 1 as covered by door 12) that may be utilized by a user when adding food to the tank 11, for example. The tank 11 shown in FIG. 1 is hexagonal. It should be realized by one of ordinary skill in the art that the hood 11 may be designed to fit over tanks having virtually any shape including, but not limited to, circular, square, rectangular, hexagonal, and octagonal. A switch 13 to activate a light (not shown) and ventilation holes 14 are also shown in FIG. 1.

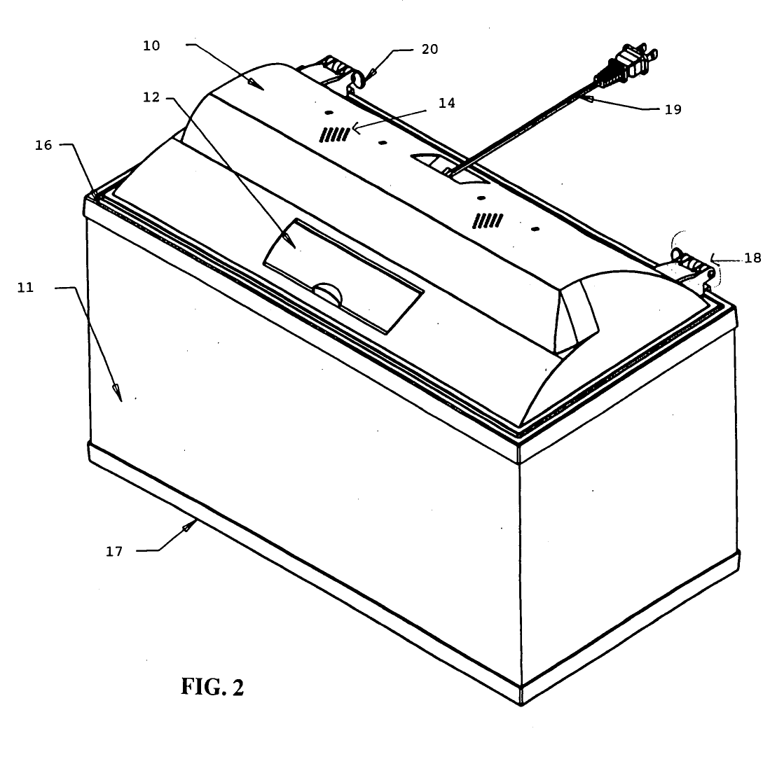

FIG. 2 is a perspective view of one embodiment of the present invention from a front angle when placed on a tank. The tank 11, which is a rectangular tank, has a top frame 16 and a bottom frame 17. The hood 10 is equipped with a power cord 19 to supply electricity as required. The hood 10 is also equipped with two hinge clips 18 that rotatably attach the hood 10 to the tank 11. The hood 11 pivots around the hinge clips 18 when raised by the user into an open configuration. When raised to an open configuration, the hood will remain raised until the user lowers the hood to its original position. Such control allows the hood 10 to remain safely attached to the tank 11 while the user is accessing the tank 10. Each hinge clip 18 includes a clip pin 20 about which the individual portions of the hinge clip 18 rotate.

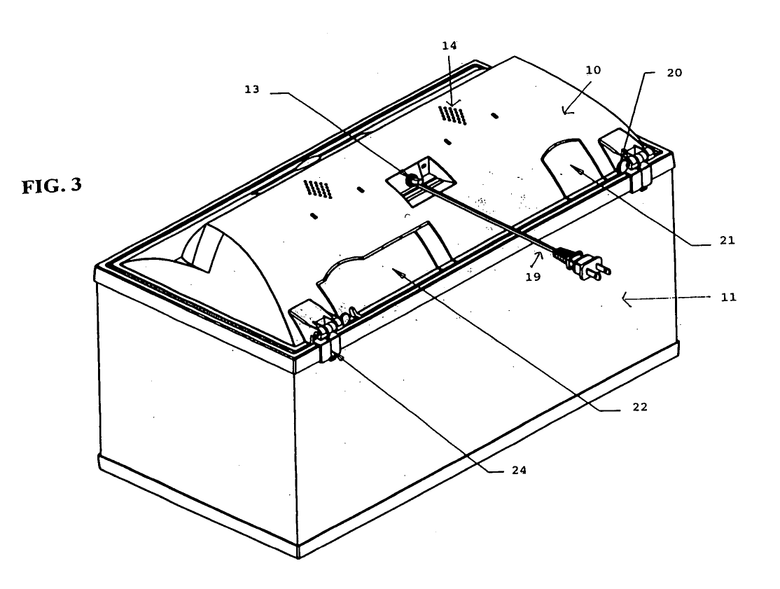

FIG. 3 is a perspective view of one embodiment of the present invention from a rear angle when placed on a tank. The hood 10 is preferably designed with a number of breakout sections that may be removed if the user desires to associate the tank 11 with aquarium accessories including, but not limited to, heaters, pumps and filters. The hood 10 as shown in FIG. 3 is equipped with a first breakout section 21 that is optimally sized for an aquarium heater and a second breakout section 22 that is optimally sized for a power filter. As should be recognized by one skilled in the art, these breakout sections 21, 22 may be placed at various locations around the periphery of the hood 10. The current placement of the breakout sections 21, 22 should not considered to be limiting. Furthermore, additional breakout sections may be placed as required.

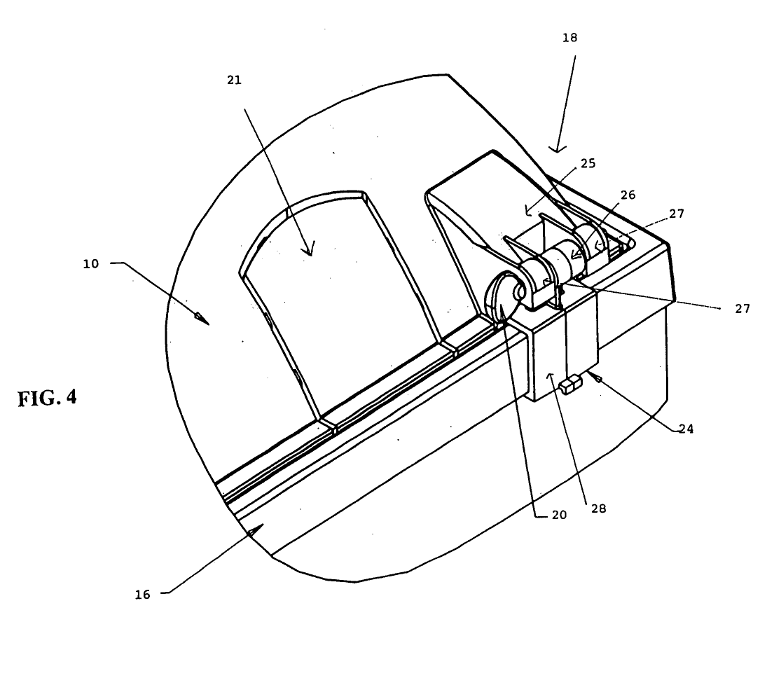

FIG. 4 is a perspective view of one embodiment of a hinge clip 18 that may be used in the present invention to rotationally connect the hood to a tank. The hinge clip 18 is generally composed of a first portion 24, a second portion 25 and a clip pin 20. The first portion 24 and the second portion 25 each have hinge portions 26 and 27, respectively, defining an opening through which the clip pin 20 extends. Hinge portion 26 is shown in FIG. 4 as lying between 2 hinge portions 27. It should be understood by one skilled in the art, however, that this configuration is not necessary. That is, hinge portion 27 may lie between two hinge portions 26. Alternatively, there may be only one hinge portion 26 and one hinge portion 27. In an alternate embodiment of the present invention, there may be a plurality of hinge portions 26, 27.

The first portion 24 of the hinge clip 18 includes a clip 28 that is designed to fit over the top frame 16. The second portion 25 is attached to, or integral to, the hood 10. This configuration allows the hood 10 to rotate while remaining attached to the tank 11.

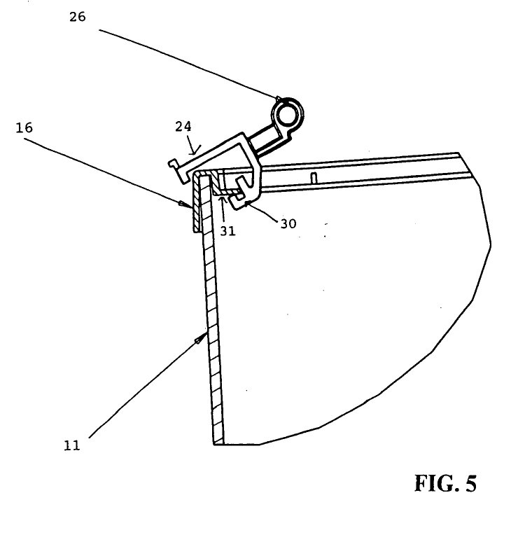

FIG. 5 is a perspective view of one embodiment of clips that may be used in the present invention to rotationally connect the hood 10 to a tank 11, in which a portion of the clip may be seen fitting over the top frame 16 of a tank 11. The first portion 24 of the hinge clip 18 has a forked portion 30 that is designed to fit around the lip 31 of the top frame 16. Once the forked portion 30 is slipped around the lip 31 of the top of the frame 16, the first portion 24 may then be rotated such that it sits flush with the top frame 16 of the tank 11. This rotation allows the forked portion 30 to sit securely around the lip 31 of the top of the frame 16.

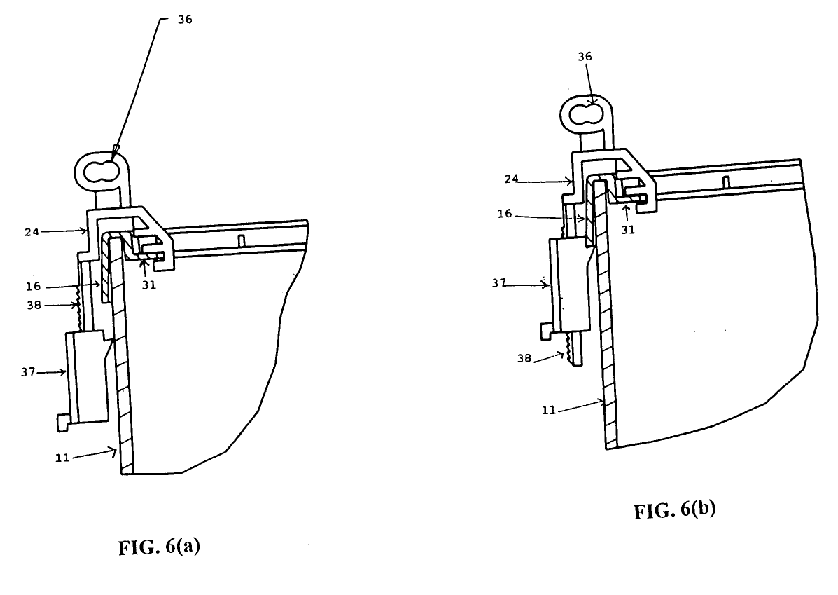

FIGS. 6(a) and 6(b) are perspective views of one embodiment of hinge clips 18 that may be used in the present invention to rotationally connect the hood 10 to a tank 11, in which the depicted hinge clip 18 is designed to fit tanks 11 having a variety of sizes. As may be seen, first portion 24 is equipped with a dual hole 36. This dual hole 36 allows the hood 10 to accommodate tanks 11 and tank frames 16 of different sizes. The first portion 24 is also equipped with a moveable piece 37 which may be adjusted to likewise accommodate tank frames of different sizes. In order to fit the hood 10 onto the tank 11, the moveable piece 37 should be adjusted such that it sits immediately below the tank frame 16. Since the hinge clip 18 in this embodiment of the present invention is designed to accommodate a number of tank sizes, the versatility of this embodiment of the present invention is increased.

The moveable piece 37 may be designed to be adjusted and moved by any means that is known in the art. For example, the moveable piece 37 may be equipped with a screw mechanism that may be tightened on arm 38 to set the depth of first portion 24. Alternatively, as shown in FIGS. 6(a) and (b), the moveable piece 37 may be designed so that it may be racheted up the arm 38. In this configuration, the arm 38 is designed with a number of teeth for the moveable piece 37 to catch.

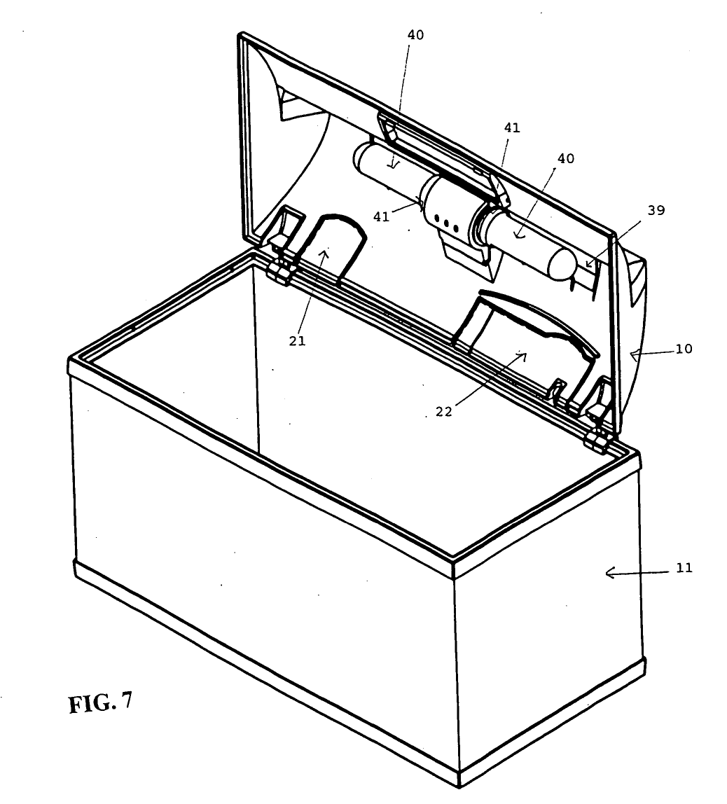

FIG. 7 is a perspective view of one embodiment of the present invention showing how the hood 11 may be rotationally opened. In this figure, breakout sections 21 and 22 may be seen. Two lamps (light bulbs) 40, which provide light to the tank 11, may also be seen. A portion of light bulb 40 is covered by a collar 41, which serves to prevent water and humidity from accessing the end of the bulb 40 that fits into the socket. The portion of the bulb 40 that is covered by the collar 41 may include, but shall not be limited to, a percentage of the metallic portion that forms the connection with the socket. It may also include a percentage of the glass portion of the bulb 40. The collar may cover a percentage of the lamp socket. In this embodiment of the invention, the collar may sit, at least in part, between the lamp socket 42 and the socket cover 43. As noted above, while the collar 41 is preferably composed of a heat-resistant elastomer, it may be formed of any appropriate relatively resilient and heat resistant material that is known in the art.

FIG. 7 also illustrates how a reflector 39 may be located “behind” a light bulb 40 so as to reflect light into the aquarium.

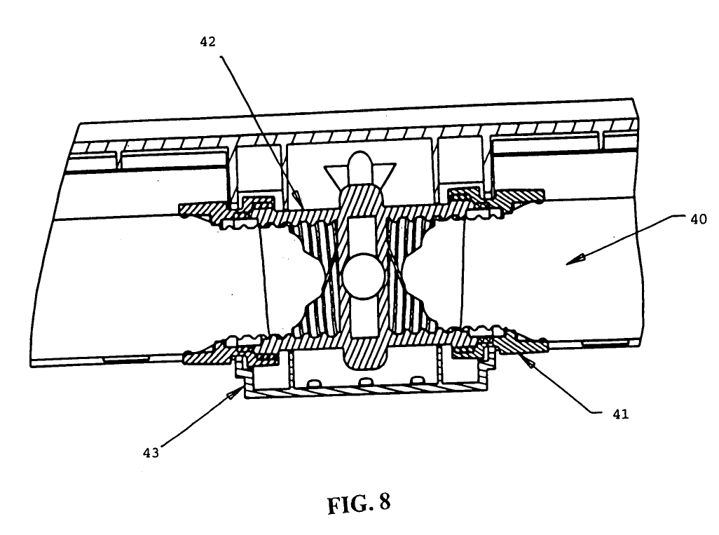

FIG. 8 is a perspective view of the lamp portion of the hood according to one embodiment of the present invention. As shown in FIG. 8, a portion of the collar 41 sits within the socket cover 43, and a portion of the collar 41 extends beyond the socket cover 43, over the bulb 40. A portion of the collar 41 also covers a portion of the exterior of the lamp socket 42. The bulb fits within the lamp socket 42, which is located below the socket cover 43.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

1. A hood and aquarium tank combination, wherein the tank has a top opening, a front and a rear, and includes a top frame extending around the periphery of the tank, the frame designed to selectively engage and position the hood, the hood including:
a top covering element generally extending over the top opening of the tank;
a retaining hinge rotatably attached to the top covering element and removably coupled to the frame, wherein the hinge comprises:
a first portion formed with and extending from the top covering element, and
a second portion joined to the first portion and selectively engaging the frame
such that the hood can rotate through an angle of at least 90° relative to the tank;
a lamp retaining mechanism located on the top covering element adjacent to the top opening of the tank and extending towards the top opening of the tank, the lamp retaining mechanism configured to hold a bulb in an alignment substantially parallel to the top covering element; and
a generally cylindrical collar joined to the lamp retaining mechanism and engaging a 15 portion of the bulb when the bulb is coupled with the lamp retaining mechanism, the collar inhibiting the passage of water around the bulb and into a socket portion of the lamp retaining mechanism.

2. The hood and aquarium tank combination as in claim 1, wherein the top covering element is composed of a first portion located towards the front of the tank, and a second, generally arcuate portion located towards the rear of the tank.

3. The hood and aquarium tank combination as in claim 1, wherein the collar is a generally cylindrical, heat-resistant elastomer collar.

4. The hood and aquarium tank combination as in claim 1, wherein the hood includes a socket cover that is disposed about at least a portion of the lamp retaining mechanism and the collar.

5. The hood and aquarium tank combination as in claim 1, wherein the top covering element defines a plurality of openings generally located above the lamp retaining mechanism.

6. The hood and aquarium tank combination as in claim 1, wherein the top covering element includes a section that may be selectively removed so that a tank accessory may be inserted through the hood and into the tank.

7. The hood and aquarium tank combination as in claim 1, wherein the top covering element further defines an opening through which a user may add food to the tank.

8. An aquarium hood for covering a top opening of an aquarium, the hood including:
a top covering element having a generally flat front portion and a generally arcuate rear portion;
a lamp retaining mechanism located on the top covering element and extending towards the top opening of the tank, the lamp retaining mechanism configured to hold a bulb in alignment substantially parallel to the top covering element;
a reflector panel located adjacent to the lamp retaining mechanism; and
a generally cylindrical collar joined to the lamp retaining mechanism and engaging a portion of the bulb when the bulb is coupled with the lamp retaining mechanism, the collar inhibiting the passage of water around the bulb and into a socket portion of the lamp retaining mechanism.

9. The hood as in claim 8, wherein the collar is generally cylindrical and heat-resistant.

10. The hood as in claim 8, wherein the top covering element defines a plurality of openings generally located above the lamp retaining mechanism.

11. The hood as in claim 8, wherein the hood includes a socket cover disposed about at least a portion of the lamp retaining mechanism and the collar.

12. The hood as in claim 8, wherein the hood includes a selectively removable section, such that a tank accessory may be inserted through the top covering element and into the tank.

13. The hood as in claim 8, further including means for rotatably joining the hood to the aquarium.

14. An aquarium hood for covering a top opening of an aquarium, the hood including:
a top covering element having a generally flat front portion and a generally arcuate rear portion;
a lamp retaining mechanism located on the top covering element and extending towards the top opening of the tank, the lamp retaining mechanism configured to hold a bulb in alignment substantially parallel to the top covering element;
a reflector panel located adjacent to the lamp retaining mechanism;
a generally cylindrical collar joined to the lamp retaining mechanism and engaging a portion of the bulb when the bulb is coupled with the lamp retaining mechanism, the collar inhibiting the passage of water around the bulb and into a socket portion of the lamp retaining mechanism; and
means for rotatably coupling the hood to an aquarium.

15. The hood as in claim 14, wherein the means for rotatably coupling the hood to an aquarium comprises a retaining hinge configured to rotatably attach the hood to the aquarium.
